(19) United States
(12) Patent Application Publication
(10) Pub. No.: US 2010/0313044 A1
(43) Pub. Date: Dec. 9, 2010

(54) STORAGE ARRAY POWER MANAGEMENT THROUGH I/O REDIRECTION

(75) Inventors: Shiv Rajpal, Sammammish, WA (US); Sompong Paul Olarig, Pleasanton, CA (US); Chris Lionetti, Duvall, WA (US); Vladimir Sadovsky, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,722

(22) Filed: Jun. 3, 2009

(51) Int. Cl. G06F 1/32; G06F 12/16; G06F 12/00; G06F 3/00; G06F 13/00

(52) U.S. Cl. 713/320; 710/18; 711/162; 710/33; 713/324

(57) ABSTRACT

A storage system can comprise multiple storage devices with differing characteristics, including differing power-related characteristics. A storage power manager can redirect Input/Output (I/O) communications to storage devices to maximize the power efficiency of the storage system. The storage power manager can reference metadata associated with the data of an I/O request, as well as power-related data, including continuously varying data and storage device characteristics, to select one or more storage devices to which to redirect the I/O. The storage power manager can also move or copy data between storage devices to facilitate maximum utilization of power efficient storage devices with limited storage capacity and to enable the placing of one or more storage devices into a reduced power consuming state. The moving or copying of data can be performed with reference to lifecycle information to identify data that has changed since a storage device was last active.

### BACKGROUND

Modern storage media includes, not only media that store data in a physically sequential manner, such as traditional magnetic and optical storage media, but also media that store data in a physically random manner, such as solid-state based storage media. Such physically random media allow any one block of data to be accessed as efficiently as any other block of data. These, and other, physical differences between the various storage media commonly available today result in storage media that differ in capability, attributes and performance. For example, magnetic and optical media require a reading and writing apparatus that physically moves from the physical location of the device head to the physical location of a block. Consequently, the speed with which such storage media can read or write data is dependent upon the proximity of the locations of the data on the media, since the device head must physically transition from one location to the other. Conversely, solid-state based storage media can read and write data through electrical signals without requiring any physically moving parts. As a result, the data stored on such media can be written, or read, with efficiency that is not dependent upon the particular location of the data on, for example, rotating media.

Of particular concern can be the power efficiency of the various types of storage media and, more specifically, of the overall storage devices in which such media are housed. For example, the physical movement of mechanisms such as the read/write heads of storage devices based on rotating media can consume as much power as the rotation of the media itself. However, to date, performance and capacity gains in storage devices utilizing rotating media has come by increasing the number of such read/write heads. Power efficiency can also be of concern because, as the power consumption of processing units and display units decreases due to designed power efficiencies, storage devices can consume a disproportionate amount of power, especially within the context of power-sensitive computing devices, such as portable computing devices that draw power from batteries or other un-tethered sources of power. Reductions in the power consumed to store and access data can enable portable computing devices to further decrease in weight and size by decreasing the amount of power required to be produced from the batteries and, thereby, enabling smaller and lighter batteries or other un-tethered sources of power. Similarly, as another example, the utilization of multiple storage devices to store and access data, such as a storage array that is presented as a single logical storage unit, or such as a storage cluster that can provide storage to multiple independent entities, can result in the consumption of a large quantity of power. In particular, not only do the storage devices themselves consume power, but at least some of that consumed power is released by the storage devices as excess heat that can be removed only through the consumption of additional power by one or more cooling systems.

### SUMMARY

Application programs and operating systems can provide indicators regarding expected utilization of data or other such metadata associated with the data being utilized by the application programs and operating systems. Storage devices can provide information regarding their characteristics, including power consumption characteristics. Additional information relevant to power consumption, such as a current cost of power, power settings of a host computing device and other like information can be received from sensors, utilities or operating systems.

In one embodiment, metadata, storage device characteristics, and available information relevant to power consumption can be utilized to select from among multiple storage devices to be utilized such that the overall storage system is made more power efficient.

In another embodiment, requests to read data from redundant storage devices can be accomplished by reading data from only one storage device and placing the other storage devices in a reduced power-consuming state.

In yet another embodiment, requests to write small amounts of data can be directed to solid-state based storage devices, with subsequent moving of the data to a larger capacity magnetic-based storage device, thereby enabling the more power consuming magnetic-based storage device to remain in a reduced power-consuming state for extended periods of time.

In a further embodiment, control of individual storage devices can be provided, including control of individual storage devices that are otherwise part of a storage array, or storage construct that is meant to be presented as a single logical storage unit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary computing device;

FIG. 2 is a layer block diagram of an exemplary series of alternative communications and objects;

FIG. 3 is a block diagram of an exemplary redirection of data for power management purposes;

FIG. 4 is another block diagram of an exemplary redirection of data for power management purposes; and

FIG. 5 is a flow diagram of an exemplary redirection of data for power management purposes.

### DETAILED DESCRIPTION

The following description relates to the minimization of the power utilized by multiple storage devices through the redirection of Input/Output (I/O) communications. The multiple storage devices can be utilized by, or be part of, a computing device benefiting from reduced power consumption, such as a portable computing device, or they can be part of a stand-alone storage system that can be managed by a computing device, or dedicated storage-centric hardware. I/O can be redirected to storage devices that consume less power, with subsequent moving of data to larger capacity, more power consuming devices. Likewise, storage devices can be placed in a reduced power consuming state when not utilized, such as redundant storage devices when data is only being read from a set of redundant storage devices. I/O redirection can be based on metadata associated with the I/O data, characteristics of the storage devices, or power-centric data collected from other sources, such as sensors or power cost data.

The techniques described herein focus on, but are not limited to, solid-state based storage devices and magnetic based storage devices arranged either as individual storage devices or in Redundant Arrays of Inexpensive Disks (RAID) configurations. To the contrary, the mechanisms described below are equally applicable to any type of storage media and any collection of such storage media and the associated storage devices, so long as characteristics of individual storage devices can be queried and the storage devices can be individually placed into states of reduced power consumption. Thus, references below to solid-state based storage devices, magnetic based storage devices, or storage devices arranged in RAID configurations are meant to be exemplary only, specifically as examples of storage media having differing power consumption characteristics, and are not meant to limit the below descriptions to specific storage mechanisms or specific storage hardware.

Although not required, the descriptions below will be in the general context of computer-executable instructions, such as program modules, being executed by one or more computing devices or dedicated storage-centric control devices or circuits integrated with one or more storage devices. More specifically, the descriptions will reference acts and symbolic representations of operations that are performed by one or more computing devices, dedicated storage-centric control devices, or circuits integrated with one or more storage devices, unless indicated otherwise. As such, it will be understood that such acts and operations include the manipulation by a processing unit of electrical signals representing data in a structured form. This manipulation transforms the data or maintains it at locations in memory, which reconfigures or otherwise alters the operation of the computing device, dedicated storage-centric control device, storage device, or other peripheral in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

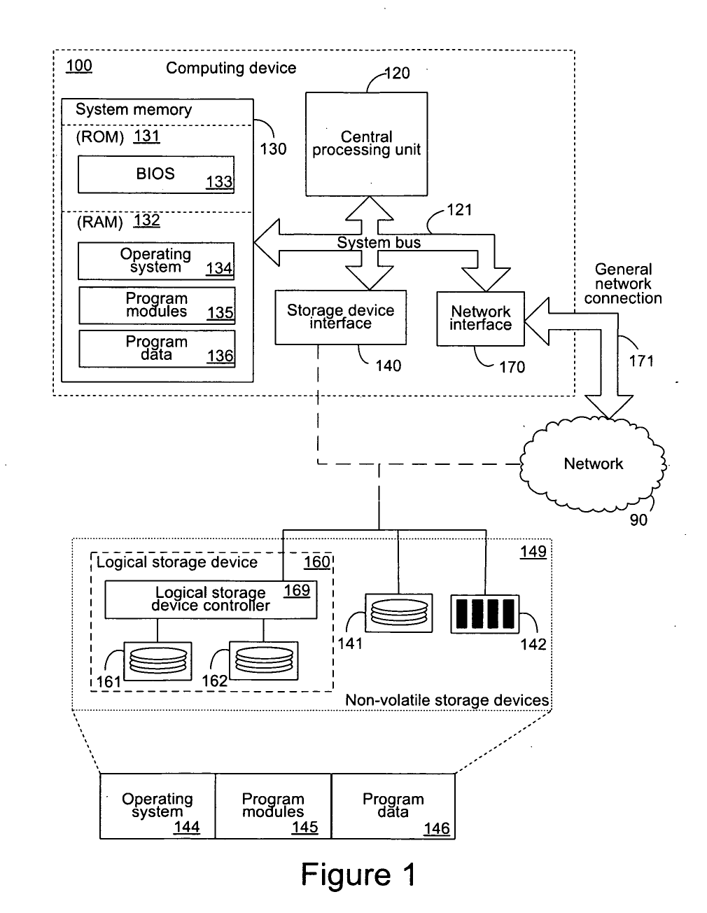

With reference to FIG. 1, an exemplary computing device 100 is illustrated, which can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus or point-to-point architectures.

The computing device 100 also typically includes computer readable media, which can include any available media that can be accessed by computing device 100, either by obtaining data from, or providing data to, such computer readable media, and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 1 illustrates an operating system 134, other program modules 135, and program data 136.

The computing device 100 may also include other removable/non-removable, volatile/nonvolatile computer storage media. FIG. 1 illustrates multiple non-volatile storage devices 149, each non-volatile storage device comprising non-volatile storage media, with the non-volatile storage devices 149 being communicationally coupled to the computing device 100 either via a storage device interface 140 that is, in turn, connected to the system bus 121, or as Network-Attached Storage (NAS) that can be communicationally coupled to the network 90 and, subsequently, to the computing device 100 through a general network connection 171 to the network 90. By way of example only, the one or more non-volatile storage devices 149 include hard disk drives 141, 161 and 162, which can utilize magnetic-based storage media, and a flash drive 142 that can utilize solid-state based storage media, including storage media based on single-level cell (SLC) or multi-level cell (MLC) based solid-state technology. Other removable/non-removable, volatile/nonvolatile computer storage media and storage devices that can be used with the exemplary computing device include, but are not limited to, FLASH memory cards, or other solid-state storage devices, including RAM disks, hard drives, magnetic tape cassettes, digital versatile disks, digital video tape and other sequential storage devices.

In the illustrated example of FIG. 1, the non-volatile storage devices 149 communicationally coupled to the computing device 100 are arranged such that the hard disk drive 141 and flash drive 142 are presented to the computing device as distinct and independent devices. Conversely, the hard disk drives 161 and 162 are exemplarily shown as part of a logical storage device 160 and can be communicationally coupled to the computing device 100 through a logical storage device controller 169. Traditionally, the logical storage device controller 169 would present both of the hard disk drives 161 and 162 as a single logical storage unit. For example, the hard disk drives 161 and 162 can be arranged in an RAID configuration or other multi-device storage configuration. However, as will be described further below, such a logical abstraction can be bypassed, enabling individual control over the operations of the individual storage devices 161 and 162.

The drives 141, 142, 161 and 162, and their associated computer storage media discussed above and illustrated in FIG. 1, provide storage of computer readable instructions, data structures, program modules and other data for the computing device 100. In FIG. 1, for example, the storage devices 149 are illustrated as storing an operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

In addition, the computing device 100 may operate in a networked environment using logical connections to one or more remote computers. For simplicity of illustration, the computing device 100 is shown in FIG. 1 to be connected to a network 90 that is not limited to any particular network or networking protocols. The logical connection depicted in FIG. 1 is a general network connection 171 that can be a local area network (LAN), a wide area network (WAN) or other network. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. Similarly, as shown in FIG. 1, one or more of the non-volatile storage devices 149, and the associated information stored on them, such as some or all of the operating system 144, program modules 145 and program data 146, can be communicationally coupled to the computing device 100 through the network 90. It will be appreciated that the network connections shown are exemplary and other means of establishing a communications link between computing devices may be used.

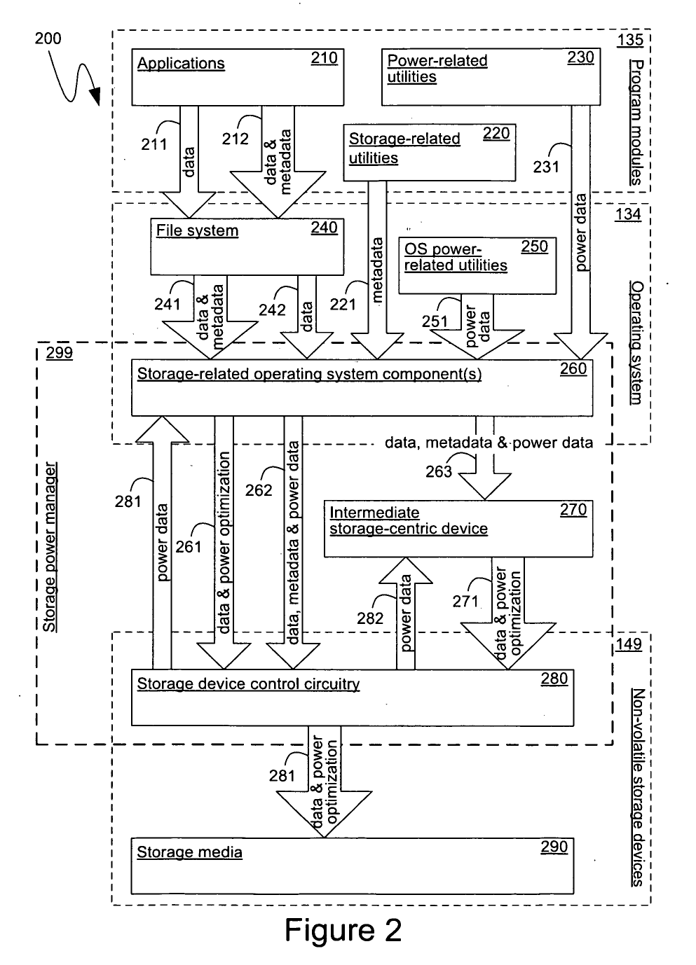

Turning to FIG. 2, more specific components or elements of the generic program modules 135 and operating system 134 of FIG. 1 are shown in the layer system 200. In particular, as shown, the generic program modules 135 of FIG. 1 can include one or more application programs, such as the applications 210, one or more storage-related utilities 220, and one or more power-related utilities. As will be known by those skilled in the art, the applications 210, the storage-related utilities 220 and the power-related utilities 230 can be comprised of computer-executable instructions that can be executed by the exemplary computing device 100 to perform various functions and tasks. Similarly, the omnibus operating system 134 of FIG. 1 can comprise computer-executable instructions directed to the implementation of, and the maintenance of, a file system 240 and operating system power-related utilities 250. The operating system 134 can further comprise one or more storage-related operating system components 260, which can comprise computer-executable instructions directed to the performance of storage-related tasks or otherwise directed to the utilization or control of the one or more storage devices 149 communicationally coupled to the computing device 100. Storage-related operating system components 260 may include, but are not limited to, operating system class and device specific drivers and associated libraries.

The storage devices 149 were illustrated in FIG. 1 as exemplarily comprising physical hard disk drives 141, 161 and 162, and a physical solid-state drive 142. As will be known by those skilled in the art, each of such drives 141, 142, 161 and 162, and any other drives that can be part of the one or more storage devices 149, can comprise controllers, processing units and firmware code (all generically referenced as storage device control circuitry 280 in the system 200 of FIG. 2) for controlling physical aspects of the device as well as internal device operational aspects, and can further comprise the storage media 290 on which the data is actually stored. Consequently, in the layered system 200 of FIG. 2, the storage devices 149 are shown as comprising one or more storage device control circuitry, such as the storage device control circuitry 280, and one or more storage media, such as the storage media 290. For purposes of the illustration provided in FIG. 2, the storage media 290 can be any of the above described storage media, including magnetic based storage media, solid-state based storage media, or any other storage media.

The one or more storage devices 149, shown in FIG. 1 as being communicationally coupled to the computing device 100 via a storage device interface 140, can, in one embodiment, be only indirectly communicationally coupled to the computing device 100. Instead, as shown in FIG. 2, the one or more storage devices 149 can be communicationally coupled to an intermediate storage-centric device 270, and the intermediate storage-centric device 270 can, then, be communicationally coupled to the computing device 100 via the storage device interface 140. Such an intermediate storage-centric device 270 can include interface or protocol adapters or translators designed to enable communications between storage devices having one type of interface and a computing device having another type of interface. Such an intermediate storage-centric device 250 can also include devices designed to amalgamate multiple devices into a single storage unit, such as a Redundant Array of Inexpensive Disks (RAID) device or a Just a Bunch Of Disks (JBOD) device and, in such a case, the intermediate storage centric-device 270 can perform functionality similar to that of the logical storage device controller 169 illustrated in FIG. 1.

In one embodiment, the applications 210 can generate data to be stored on a storage medium such as one or more of the storage media 290. Traditionally, such data generated by the applications 210 would be provided to the file system 240 of the operating system 134 for storage onto a storage media. Thus, as shown in the system 200, a communication 211 from the applications 210 to the file system 240 can provide data generated by the applications that is to be stored on a storage medium. In an alternative embodiment, the applications 210 can generate both data to be stored on a storage medium and information about that data, traditionally called “metadata”. The data and corresponding metadata can likewise be provided by the applications 210 to the file system 240, as indicated by the communication 212 of system 200.

If the file system 240 was provided only data from the applications 210, as illustrated by communication 211, then, in one embodiment, the file system 240 can generate metadata associated with the data received from the applications 210. Subsequently, the file system 240 can provide the data and associated metadata, whether received from the applications 210 or generated by the file system itself, to storage-related operating system components 260 for storage on one or more of the storage devices 149. Such a provision of data and metadata from the file system 240 to the storage-related operating system components 260 is illustrated by the communication 241 of system 200.

In another embodiment, the file system 240 either may not be capable of generating, or may not have sufficient information from which to generate, metadata associated with the data from the applications 210 received via communication 211. In such an embodiment, the file system 240 can pass the data received from the applications 210 to other operating system components, such as the storage-related operating system components 260 without adding metadata, as illustrated by communications 242 of the system 200. In such an embodiment, metadata associated with the data of communication 242 can be provided by, for example, one or more storage-related utilities 220. Such storage-related utilities 220 can include specialized utilities, comprising computer-executable instructions directed to monitoring data access by, for example, the applications 210 and generating associated metadata from empirically derived information. Thus, as shown in the system 200, storage-related utilities 220 can provide metadata, via communication 221, directly to the storage-related operating system components 260, bypassing the file system 240. In such an embodiment, the metadata provided by communication 221 can have been the result of, for example, batch execution on file system logs, in addition to, or as an alternative to, the monitoring described above. In another embodiment, not specifically shown to avoid illustrative clutter and maintain visual clarity, the storage-related utilities 220 can act inline with the file system 240, such as through filter drivers. In such an embodiment, the metadata shown via external communication 221 may be more internal to the file system 240 and can be analogous to the communication 241, despite the provision of the metadata by the storage related utilities 220.

In addition to data to be stored on the storage media 290, and any metadata that is associated with it, the storage-related operating system components 260 can also receive information relevant to decisions regarding power efficiency. For example, such power data can include information as to the current cost of power at the location of the computing device 100, the current power settings or options selected by a user of the computing device, whether the computing device and the storage devices 149 are operating on battery power, or other emergency backup power, and other like information. In one embodiment, the program modules 135 can comprise power-related utilities 230 that monitor and obtain information relevant to decisions regarding power efficiency. For example, the power-related utilities 230 can obtain, such as via the network 90, the current cost of power at the location of the computing device 100. As another example, the power-related utilities 230 can communicate with external sensors and can, thereby, obtain power-related sensor data, such as the current rate of consumption of power as measured from a power source, or other like information. Such information can be provided by the power-related utilities 230 to the storage-related operating system components 260, as shown by the communication 231 of the system 200.

Power data can likewise be provided by components of the operating system 134, illustrated generically in FIG. 2 as the operating system power-related utilities 250. As will be recognized by those skilled in the art, the OS power-related utilities 250 can include battery and power management utilities that are typically part of the operating system 134, as well as other more specialized, or more complex, utilities. Like the power-related utilities 230, the OS power-related utilities 250 can provide power data 251 to the storage-related operating system components 260. Such power data can include information on the current power management state of the computing device 100 selected by the user, the current battery state of the computing device, or whether the computing device and the storage device 149 are otherwise drawing power from an auxiliary power supply, and other like information.

Power data can also be generated, and provided, by the storage devices 149 themselves. As shown in the system 200, the storage device control circuitry 280 of the storage devices 149 can provide power data to the storage-related operating system components 260, such as with the communications 281, or to the intermediate storage centric-device 270, such as with the communications 282. As with the above examples, the power data provided by the storage devices 149 themselves can comprise data that can be relevant to decisions regarding power efficiency, such as, for example, a rated power consumption of the particular storage device providing such data, or, alternatively, data from which the power consumption can be estimated, such as, for example, a rotational speed or a type of storage media utilized by the storage device. While the power data provided by the power-related utilities 230, and the OS power-related utilities 250 can be continuously provided during the operation of the computing device 100 and the storage devices 149, in one embodiment, the power data provided from the storage devices themselves can be provided during an initial time, such as when the storage devices are first communicationally connected to the computing device, since at least some of the power data provided by the storage devices can be static data that reflects characteristics of the storage devices and, consequently, can be non-varying.

In one embodiment, the storage-related operating system components 260 of the operating system 134 can comprise traditional storage-related operating system components, such as, for example, device drivers and other components responsible for communicating with the storage devices 149. In such an embodiment, metadata and power data received by the storage-related operating system components 260, such as via communications 221, 231, 241 and 251, as well as any data associated with the metadata, can be passed, by the storage-related operating system components, to either the storage device control circuitry 280 (including controllers and firmware) of the storage devices 149, as shown by communication 262 of the system 200, or to intermediate storage-centric devices, such as the intermediate storage-centric device 270, as shown by communication 263.

In another embodiment, however, the storage-related operating system components 260 of the operating system 134 can further comprise components that provide, at least in part, redirection of I/O communications to and from the storage devices 149. More specifically, as will be described further below, computer-executable instructions that are part of the storage-related operating system components 260 can, in this embodiment, utilize the metadata, power data and other information received through communications 221, 231, 241, 242 and 251, as well as any information generated internally by the storage-related operating system components themselves, to determine to which storage medium, of the storage media 290 to send the data generated by the applications 210 or the file system 240, from which storage medium to obtain data requested by the applications or the file system, or between which storage media to move data. In such an embodiment, rather than providing the metadata and power data to further downstream elements, the storage-related operating system components 260 can, instead perform the I/O redirection itself and can, such as with communication 261, instruct the storage device control circuitry 280 appropriately.

Returning to the previously described embodiment, if the storage-related operating system components 260 merely passed the metadata, power data and other information received from upstream components, or generated internally, such as indicated by communications 262 or 263, then the I/O redirections, indicated above, can, instead, in one embodiment, be made by the intermediate storage-centric device 270, or, in another embodiment, by the storage device control circuitry 280 of one or more of the storage devices 149. More specifically, as shown in the system 200 of FIG. 2, in one embodiment, the storage-related operating system components 260 can provide data, metadata, power data and other like information to the intermediate storage-centric device 270 via communication 263. The intermediate storage-centric device 270 can then appropriately redirect I/O, such as will be described further below, and provide the relevant instructions to the storage devices 149, such as via communication 271. In an alternative embodiment, the storage-related operating system components 260 can provide policy, indicators, or other like information, not to the intermediate storage-centric device 270, but rather directly to the storage devices 149, such as via communication 262. In such an embodiment, the storage device control circuitry 280 of those storage devices 149 that receive the communication 262 can, like the storage-related operating system components 260, or the intermediate storage-centric device 270 in the embodiments previously described, redirect I/O to provide for greater power efficiency.

As can be seen, I/O redirection can be made by processes executing on the computing device 100, such as, for example, the storage-related operating system components 260, by the storage devices 149 themselves, such as, for example, by the storage device control circuitry 280, or by a storage-centric device intermediate between the computing device and the storage devices, such as, for example, the intermediate storage-centric device 270. Consequently, the storage power manager 299, which will be described in more detail below, is shown in FIG. 2 to include a combination of any one or more of the afore-mentioned storage-related operating system components 260, intermediate storage-centric device 270, and the storage device control circuitry 280. As used in the description below, therefore, the term “storage power manager” means any component, device, or combination of components and/or devices, that identifies and instructs redirection of I/O communications or data storage to achieve power efficiencies.

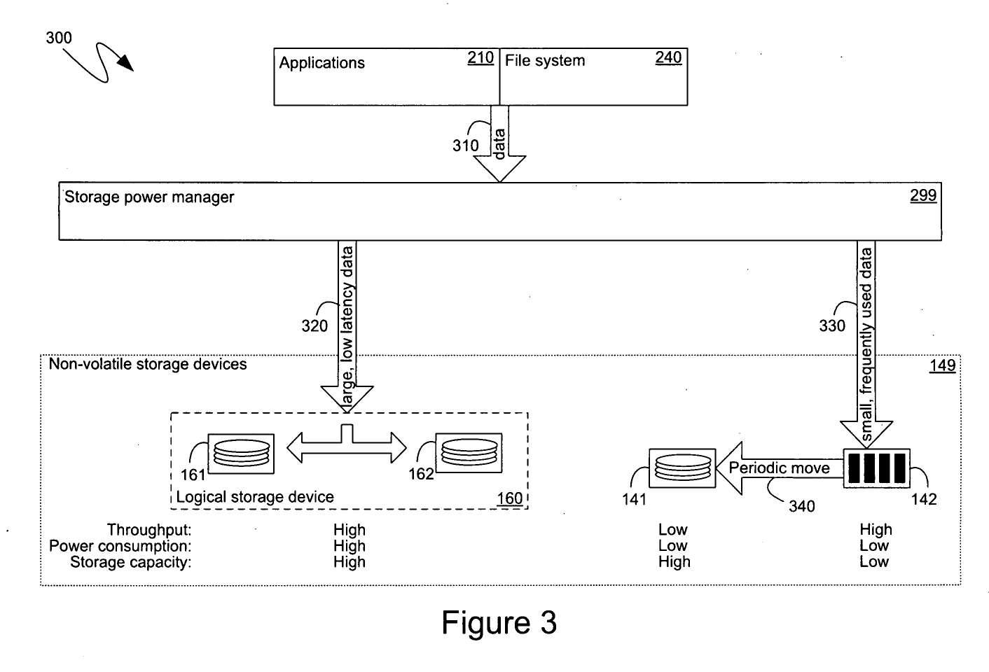

Turning to FIG. 3, the operation of the storage power manager 299 is described in greater detail with respect to the system 300. As shown in FIG. 3, the system 300 comprises the applications 210, the file system 240, the storage devices 149, and the storage power manager 299, which, as indicated previously, can include one or more components or elements from among the computing device 100 (as illustrated in FIG. 1), the storage devices 149, and any intermediate storage-centric devices 270. The storage power manager 299 can receive, as indicated previously, input that can be utilized to redirect I/O communications to particular storage devices, from among the storage devices 149, so as to render the overall storage system more power efficient. As indicated previously, although not specifically illustrated in the system 300 of FIG. 3, such inputs can include metadata associated with the data that is to be stored on, or retrieved from the storage devices 149 and power data that can provide information regarding power consumption, power cost, available power and other like power-related factors.

In one embodiment, as shown in the system 300, the storage power manager 299 can receive data 310 from the applications 210 or the file system 240 that the applications or file system have requested to be stored on the storage devices 149. The storage power manager 299 can then select one or more storage devices, from among the storage devices 149, to which to redirect such an I/O communication and store the data 310. Such a I/O redirection can be based on any metadata that can be associated with the data 310 or based on any relevant power data that the storage manager 299 may have received. For example, if the data 310 comprises a large quantity of data and has metadata associated with it that indicates that the data is being utilized by applications 210 that require low latency, then the storage power manager 299 can store such data on storage devices that have a high throughput and, when aggregated together, a large storage capacity, such as the logical storage device 160 that comprises multiple storage devices 161 and 162 that can act in an aggregate manner to provide greater capacity while retaining the high performance of the individual high-throughput storage devices 161 and 162. Thus, as shown by the communication 320, data, such as large quantities of data that require low latency, can be redirected by the storage power manager 299 to the storage devices 161 and 162. As another example, if the data 310 comprises a small quantity of data that is frequently used and changed, then the storage power manager 299 can store such data on storage devices that can provide sufficient performance while consuming less power than other available storage devices, such as the solid-state based storage device 142. Thus, as shown by the communication 330, for small, frequently used data, the storage power manager 299 can redirect such I/O to, for example, the solid-state based storage device 142.

Power data received by the storage power manager 299 can inform and, in some cases, modify I/O redirections that can be performed by the storage power manager. For example, the redirection of smaller sized data to the solid-state based storage device 142 can be based on the fact that such a storage device can provide high throughput, like the logical storage device 160, but can do so as a single storage device and, consequently, consume less power than the logical storage device 160, which can comprise multiple storage devices, such as storage devices 161 and 162, each of which can, individually, consume as much, or even more, power than the solid-state based storage device 142. However, as will be known by those skilled in the art, the logical storage device 160 can provide a greater storage capacity than the solid-state based storage device 142 and, as a result, the storage power manager 299 can limit the realization of power savings that the solid-state based storage device 142 provides over, for example, the logical storage device 160, to data that is appropriately sized for the significantly smaller storage capacity of the solid-state based storage device.

The power consumption of a storage device, such as the solid-state based storage device 142 can be based on power data received by the storage power manager 299 from such a device. In one embodiment, storage devices, such as the solid-state based storage device 142 can provide information, such as power consumption, to the storage power manager 299, such as during an initial handshake or other preliminary protocol by which the storage devices and the storage power manager establish communications. In an alternative embodiment, storage devices can, instead, merely provide identifying information to the storage power manager 299, and the storage power manager can reference a database, such as via the network 90, that can provide detailed, including empirically derived, power consumption information for storage devices based on the provided indentifying information.

In another embodiment, the storage power manager 299 can move stored data between storage devices to enable greater power efficiency. For example, the solid-state based storage device 142 can provide high throughput storage services at low power consumption, but only with a limited storage capacity. Rather than utilizing multiple solid-state based storage devices, where each device would consume yet more power, the storage power manager can seek to limit the quantity of information stored on the single solid-state based storage device 142 by periodically transferring data to a larger capacity storage device 141 that may not have the throughput of the solid-state based storage device. Thus, to maximize the power efficiency, the storage power manager 299 can, periodically, move data from the solid-state based storage device 142 to another device, such as the magnetic-based storage device 141, to provide additional free capacity on the solid-state based storage device. In one embodiment, such a periodic move 340, can reference lifecycle information, or other information about the data stored on the solid-state based storage device that indicates the frequency of access, or the age, of the data stored on the solid-state based storage device. The storage power manager 299, with such lifecycle data, can then perform the periodic move 340 to move less used, or older data, to a slower throughput storage device, such as the magnetic-based storage device 141 that can comprise a greater storage capacity, thereby freeing storage capacity on the solid-state based storage device 142 for newly generated data and, thereby, maximizing the power savings generated through the use of the solid-state based storage device.

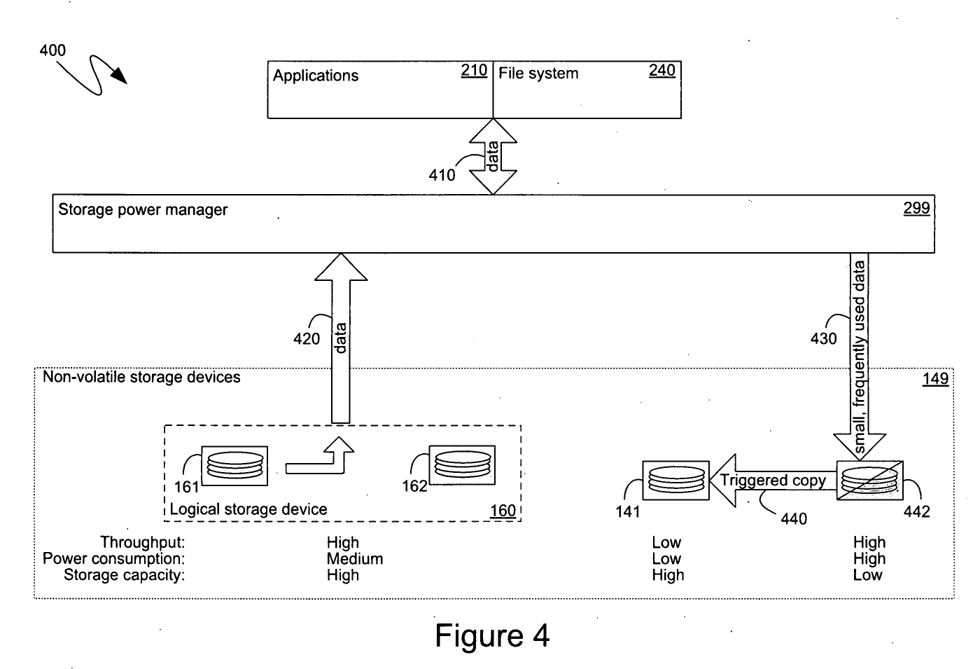

Another example of the moving of data, such as the periodic move 340 described above, is illustrated by the system 400 of FIG. 4. Turning to FIG. 4, the system 400 is analogous to the system 300, again comprising the applications 210, file system 240, storage power manager 299, and the storage devices 149. For purposes of illustrating another example of moving data, however, the solid-state based storage device 142 of the system 300, as illustrated in FIG. 3, has, in the system 400 of FIG. 4, been replaced by a magnetic-based storage device 442 that can, like the solid-state based storage device provide increased throughput. However, unlike the solid-state based storage device 142, in the example illustrated by the system 400, the magnetic-based storage device 442, as can be common for high-throughput magnetic-based storage devices, can consume a relatively large quantity of power. Consequently, as another example of moving data, the storage power manager 299 can still utilize the high-throughput magnetic-based storage device 442 to store small, frequently used data, as indicated by the communication 430, but can then, during periods of inactivity, trigger a copy 440 of the data of the storage device 442 to a more power efficient storage device, such as the magnetic-based storage device 141 and can, subsequently, place the high-throughput magnetic-based storage device 442 into a reduced power consuming state. Thus, as shown in FIG. 4 via the gray shading, the high-throughput magnetic-based storage device 442 can be placed into a reduced power consuming state after the triggered copy 440 has copied, the data stored on such a storage device to another, lower power consuming storage device, such as the magnetic-based storage device 141.

In an embodiment where a storage device, such as the high-throughput magnetic-based storage device 442 has been placed into a reduced power consuming state, and its data has been copied to a lower power consuming storage device, such as the magnetic-based storage device 141, the storage power manager 299 can redirect further I/O communications to the storage device 141. Thus, for example, should one of the applications 210 or the file system 240 seek to retrieve data originally stored on the high-throughput magnetic-based storage device 442, such requests can, instead, be redirected by the storage power manager 299 to the magnetic-based storage device 141 and provided from such a storage device. In one embodiment, should the storage activity of the magnetic-based storage device 141 increase beyond its capabilities, the high-throughput magnetic-based storage device 442 can be returned to an active state by the storage power manager 299 and the data that had been changed on the storage device 141 while the high-throughput magnetic-based storage device 442 was in the reduced power consuming state can be copied back to the high-throughput magnetic-based storage device 442. In such a case, subsequent I/O can be redirected by the storage power manager 299 to the high-throughput magnetic-based storage device 442.

The placing of storage devices into reduced power consuming states can be performed by the storage power manager 299 even for logical storage devices that abstract multiple individual storage devices. For example, as indicated previously, the logical storage device 160 can abstract multiple storage devices, such as the storage devices 161 and 162, including, for example, by arranging the multiple storage devices 161 and 162 into a redundant arrangement, such as a RAID. In one embodiment, the storage power manager 299 can obtain individual control of the storage devices 161 and 162 of a logical storage device 160, such as through an appropriate handshake protocol, or other like communicational exchange, with the logical storage device controller 169 (illustrated previously in FIG. 1). Subsequently, the storage power manager 299 can individually place one or more of the multiple physical storage devices of a single logical storage device into a reduced power consuming state.

For example, and turning back to FIG. 3, the logical storage device 160 of the system 300 is shown as comprising two storage devices 161 and 162 that can be arranged in a redundant arrangement, such as provided by various types of RAIDs. Consequently, as will be known by those skilled in the art, the provision of data to such a logical storage device 160 can comprise the storage of such data on both of the storage devices 161 and 162. Thus, as shown in the system 300, the data 320 provided to the logical storage device 160 is equally stored on both of the storage devices 161 and 162. Subsequently, however, a substantial portion of the storage activity directed to the data stored on the logical storage device 160 can be in the form of requests to read and retrieve the stored data. In such a case, the storage power manager 299 can place one of the redundant storage devices 161 or 162 into a reduced power consuming state, and provide the requested data exclusively from the other redundant storage device.

Turning back to FIG. 4, the system 400 illustrates such an embodiment, wherein the redundant storage device 162 has been placed, by the storage power manager 299, into a reduced power consuming state, as indicated by the gray shading. Requested data 420 can be provided exclusively from the active storage device 161 since, by virtue of the redundant arrangement of the storage devices 161 and 162, the active storage device 161 can have stored on it the same data as the storage device 162 in the reduced power consuming state. In another embodiment, not specifically illustrated in FIG. 4, a minimal quantity of requests to store data on the logical storage device 160 can be directed to the active storage device 161 without activating the storage device 162 in the reduced power consuming state. Subsequently, when the storage device 162 is reactivated, the changed data can be copied from the storage device 161 that had remained active to the storage device 162. As before, such a copy can be made with reference to lifecycle information, or other like information that can indicate the time when specific data stored on the storage devices was last changed.

In addition to redirection of I/O communications and, if appropriate copying or moving data among the storage devices 149, such as to facilitate the placing of at least some of the storage devices into a reduced power consuming state, the storage power manager 299 can also, in one embodiment, take into account continuously varying power-related information. More specifically, as indicated previously, power data can comprise information about the current cost of power, the currently available power, such as, for example, whether the computing device 100 and the storage devices 149 were being powered from a battery or an uninterruptable power supply, and the quantity of currently available power, such as the remaining battery capacity. The storage power manager 299 can take into account such varying information and can adjust its I/O redirection, or other actions, accordingly. For example, if power data provided to the storage power management indicated that available battery power for the computing device 100 and the storage devices 149 was nearly exhausted, the storage power manager 299 can determine to place redundant storage devices, such as the storage device 162 into a reduced power consuming state, thereby trading redundancy and data safety for increased power efficiency. Similarly, if the power data provided to the storage power manager 299 indicated that the current cost of power was low, such as in the middle of the night, the storage power manager could leave the high-throughput magnetic-based storage device 442 active and avoid the need to make the copy 440 of its data to a lower power consuming storage device, such as the magnetic-based storage device 141.

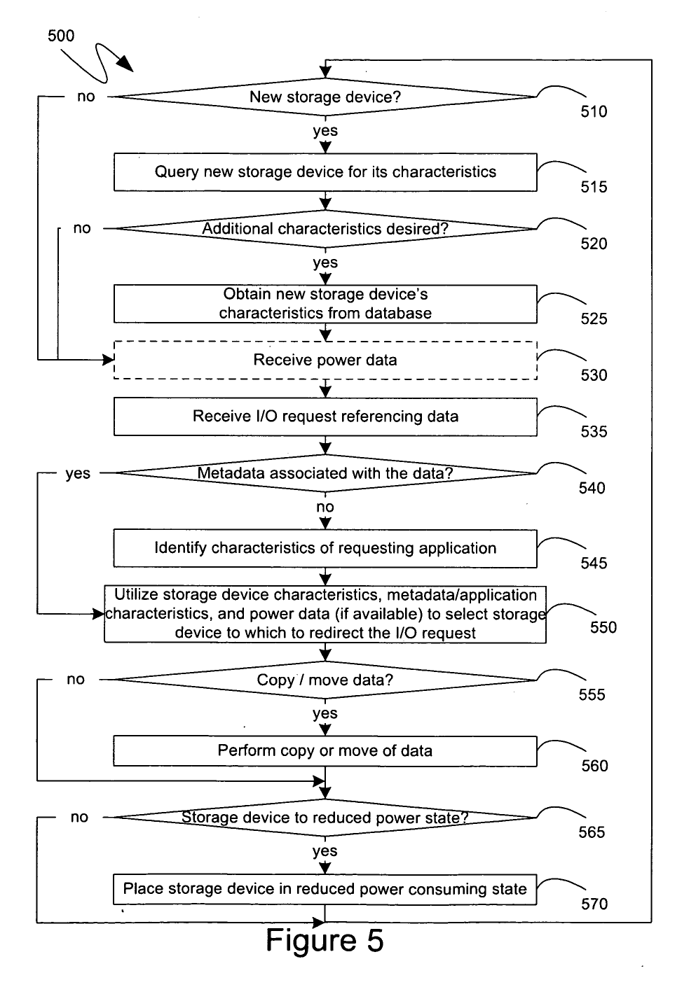

Further to the provided descriptions and examples, the operation of the storage power manager 299 is additionally described with reference to the flow diagram 500 of FIG. 5. Turning to FIG. 5, the flow diagram 500 illustrates an exemplary series of steps that can provide context for the above descriptions and examples. As can be seen, initially, at step 510, a determination can be made regarding the detection or presence of any new storage devices. In one embodiment, such a determination can traditionally identify new storage devices during a powering on, or resetting of the computing device 100, or of one or more of the storage devices 149. If no new storage device is identified at step 510, processing can skip to the optional step 530, described further below. However, if a new storage device is identified at step 510, its characteristics can be queried at step 515. As indicated, the characteristics requested and received at step 515 can comprise power-related characteristics, such as the power consumption of the storage device, special reduced power consuming states, if any, the storage mechanisms of the storage device, such as whether it is a solid-state based storage device or a magnetic based storage device, and other like information. The characteristics requested and received at step 515 can likewise comprise other characteristics of the new storage device, such as its capacity, its throughput, its fragmentation, its usage cycles, and other relevant information.

Subsequently, at step 520, a determination can be made regarding the desirability of additional characteristics of the new storage device. For example, as indicated previously, if the storage device was not capable of being queried, such as in step 515, the storage device may not have provided much, if any, information. The characteristics received from the storage device at step 515 may have only comprised identifying information, such as a model number, manufacturer name and serial number, if even that much. In such a case, if, at step 520, it is determined that additional characteristics, such as the power-related characteristics described above, are desired, then, at step 525, a database or other external data source can be referenced to obtain additional characteristics of the storage device, such as based on the indentifying information provided at step 515. As indicated previously, the database, or other source consulted at step 525, can comprise data received from the manufacturer, empirical data, user submitted data, or other data from like sources. Alternatively, or in addition to referencing such an external data source, a profiling of the device can be performed, such as by observing the device's performance or power consumption through a pre-determined cycle of tests. The information collected through such profiling can be stored in an information file on the storage device itself for easier subsequent access. For example, such an information file could be stored on the storage device in a utility area that may not be available for more traditional storage of data. If, on the other hand, the characteristics received at step 515 are found to be sufficient by the determination at step 520, then step 525 can be skipped and processing can proceed with step 530.

At step 530, power data, including the continuously varying power data described above, can be received. While, as indicated, such data can enable the storage power manager 299 to make more informed power management decisions and I/O redirections, such data can be optional. Consequently, step 530 of the flow diagram 500 of FIG. 5 is illustrated with dashed lines to indicate that it is an optional step.

Irrespective of whether power data is received at step 530, at step 535, an I/O request can be received regarding the storage devices 149. As will be known by those skilled in the art, such an I/O request can comprise a request to read data from a storage device or store data, or modify data, on a storage device. Upon receiving such a request at step 535, a determination can be made at step 540 regarding any available metadata that is associated with the data of the I/O request of step 535. As indicated above in connection with FIG. 2, such metadata can be provided by a variety of sources, including the application associated with the data, the file system, other utilities, or other sources. If, at step 540, no metadata is found to be associated with the data of the I/O request of step 535, characteristics of the application requesting the I/O can be identified at step 545 or other information can be gathered that can aid in the redirection of the I/O request to an appropriate storage device. However, if, at step 540, metadata associated with the data of the I/O request of step 535 was located, processing can skip step 545 and can proceed to step 550.

At step 550, the available information, including storage device characteristics received at steps 515 and 525, metadata received at step 540, power data received at step 530 and any other relevant data, can be considered and one or more storage device to which to redirect the I/O request can be identified. As described above, such a redirection can seek to select one or more optimal storage devices given the intended usage of the data, such as could be derived from any available associated metadata or other like information, while simultaneously minimizing the power utilized by the overall storage system to which the storage device belong, as could be determined from power data and storage device characteristics.

After redirecting the I/O, at step 550, to the selected storage device or storage devices, a determination can be made at step 555 as to whether data should be copied or moved from any of the storage devices. As detailed above, if a utilized storage device has a limited storage capacity, data can be periodically moved from such a storage device to a less desirable storage device to maximize the energy savings from using such a storage device. Alternatively, if a storage device has been reactivated from a reduced power consumption state, step 555 can identify such a device as a device that can receive updated data from an alternative storage device that was utilized while that storage device was in the reduced power consuming state. If, at step 555, it is determined that no data should be moved or copied, processing can skip to step 565. However, if, at step 555, it is determined that data should be moved or copied to or from a storage device, then, at step 560, such a move or copy can be performed. As indicated, in one embodiment, such a move or copy can reference lifecycle information, or other historical information, to identify the data that should be moved or copied.

Subsequently, at step 565, a determination can be made regarding the placing of one or more storage devices into a reduced power consuming state. As indicated previously, redundant storage devices can be placed into a reduced power consuming state while requests for data from such an array of redundant storage devices can be serviced by the remaining, active storage devices. Similarly, during periods of reduced storage activity, high power consuming storage devices can be placed into a reduced power consuming state while lower power consuming storage devices that may not have as high a throughput can be utilized instead. If, at step 570, no storage device is identified that can be placed into a reduced power consuming state, then processing can return to step 510, as shown. However, if, at step 570, one or more storage devices are identified that can be placed into a reduced power consuming state, then, at step 570, the identified storage devices of step 565 can be placed into a reduced power consuming state and, subsequently, processing can return to step 510, as shown.

As can be seen from the above descriptions, mechanisms for redirecting I/O to storage devices so as to maximize the power efficiency of a storage system with multiple storage devices have been provided. In view of the many possible variations of the subject matter described herein, we claim as our invention all such embodiments as may come within the scope of the following claims and equivalents thereto.

We claim:

1. One or more computer-readable media comprising computer-executable instructions for redirecting Input/Output (I/O) requests among multiple heterogeneous storage devices for power efficiency purposes, the computer-executable instructions directed to steps comprising:
obtaining characteristics of the multiple heterogeneous storage devices, the characteristics comprising characteristics indicative of power consumption and characteristics indicative of storage-related performance;
receiving an I/O request from a client;
selecting at least one of the multiple heterogeneous storage devices to which to redirect the I/O request based on the characteristics indicative of power consumption and the characteristics indicative of storage-related performance so as to minimize both a power consumption of the multiple heterogeneous storage devices and a storage-related performance impact on the client; and
redirecting the I/O request to the selected at least one of the multiple heterogeneous storage devices.

2. The computer-readable media of claim 1, comprising further computer-executable instructions for receiving metadata associated with data referenced by the I/O request; wherein the selecting the at least one of the multiple heterogeneous storage devices is further based on the metadata.

3. The computer-readable media of claim 1, comprising further computer-executable instructions for receiving varying power-related information; wherein the selecting the at least one of the multiple heterogeneous storage devices is further based on the varying power-related information.

4. The computer-readable media of claim 1, wherein the computer-executable instructions directed to the obtaining the characteristics of the multiple heterogeneous storage devices comprise computer-executable instructions directed to referencing a data source external to the multiple heterogeneous storage devices to obtain further characteristics of the multiple heterogeneous storage devices based on an identification of the multiple heterogeneous storage devices received from the multiple heterogeneous storage devices.

5. The computer-readable media of claim 1, comprising further computer-executable instructions directed to: selecting data to move from a more power efficient storage device of the multiple heterogeneous storage devices to a less power efficient storage device of the multiple heterogeneous storage devices by referencing lifecycle information associated with the data; and moving the selected data from the more power efficient storage device to the less power efficient storage device so as to maximize utilization of the more power efficient storage device to minimize the power consumption of the multiple heterogeneous storage devices.

6. The computer-readable media of claim 1, comprising further computer-executable instructions directed to: copying data from a less power efficient storage device of the multiple heterogeneous storage devices to a more power efficient storage device of the multiple heterogeneous storage devices; and placing the less power efficient storage device into a reduced power consuming state; wherein the redirecting the I/O request comprises redirecting I/O requests from the less power efficient storage device to the more power efficient storage device.

7. The computer-readable media of claim 6, comprising further computer-executable instructions directed to: restoring the less power efficient storage device to an operational state from the reduced power consuming state in response to an increase in storage activity associated with the more power efficient storage device; selecting data to copy from the more power efficient storage device to the less power efficient storage device based on lifecycle information indicating that the data being selected changed since the less power efficient storage device was placed into the reduced power consuming state; and copying the selected data from the more power efficient storage device to the less power efficient storage device; wherein the redirecting the I/O request comprises redirecting I/O requests back to the less power efficient storage device upon completion of the copying.

8. A method of redirecting Input/Output (I/O) requests among multiple heterogeneous storage devices for power efficiency purposes comprising the steps of:
obtaining characteristics of the multiple heterogeneous storage devices, the characteristics comprising characteristics indicative of power consumption and characteristics indicative of storage-related performance;
receiving an I/O request from a client;
selecting at least one of the multiple heterogeneous storage devices to which to redirect the I/O request based on the characteristics indicative of power consumption and the characteristics indicative of storage-related performance so as to minimize both a power consumption of the multiple heterogeneous storage devices and a storage-related performance impact on the client; and
redirecting the I/O request to the selected at least one of the multiple heterogeneous storage devices.

9. The method of claim 8, further comprising the steps of receiving metadata associated with data referenced by the I/O request; wherein the selecting the at least one of the multiple heterogeneous storage devices is further based on the metadata.

10. The method of claim 8, further comprising the steps of receiving varying power-related information; wherein the selecting the at least one of the multiple heterogeneous storage devices is further based on the varying power-related information.

11. The method of claim 8, wherein the obtaining the characteristics of the multiple heterogeneous storage devices comprises referencing a data source external to the multiple heterogeneous storage devices to obtain further characteristics of the multiple heterogeneous storage devices based on an identification of the multiple heterogeneous storage devices received from the multiple heterogeneous storage devices.

12. The method of claim 8, further comprising the steps of: selecting data to move from a more power efficient storage device of the multiple heterogeneous storage devices to a less power efficient storage device of the multiple heterogeneous storage devices by referencing lifecycle information associated with the data; and moving the selected data from the more power efficient storage device to the less power efficient storage device so as to maximize utilization of the more power efficient storage device to minimize the power consumption of the multiple heterogeneous storage devices.

13. The method of claim 8, further comprising the steps of: copying data from a less power efficient storage device of the multiple heterogeneous storage devices to a more power efficient storage device of the multiple heterogeneous storage devices; and placing the less power efficient storage device into a reduced power consuming state; wherein the redirecting the I/O request comprises redirecting I/O requests from the less power efficient storage device to the more power efficient storage device.

14. The method of claim 8, further comprising the steps of: restoring the less power efficient storage device to an operational state from the reduced power consuming state in response to an increase in storage activity associated with the more power efficient storage device; selecting data to copy from the more power efficient storage device to the less power efficient storage device based on lifecycle information indicating that the data being selected changed since the less power efficient storage device was placed into the reduced power consuming state; and copying the selected data from the more power efficient storage device to the less power efficient storage device; wherein the redirecting the I/O request comprises redirecting I/O requests back to the less power efficient storage device upon completion of the copying.

15. A power optimized storage system providing storage services to at least one client, the power optimized storage system comprising:
multiple heterogeneous storage devices;
at least one processing unit; and
instructions for execution by the at least one processing unit that cause the at least one processing unit to perform steps comprising:
obtaining characteristics of the multiple heterogeneous storage devices, the characteristics comprising characteristics indicative of power consumption and characteristics indicative of storage-related performance;
receiving an I/O request from the at least one client;
selecting at least one of the multiple heterogeneous storage devices to which to redirect the I/O request based on the characteristics indicative of power consumption and the characteristics indicative of storage-related performance so as to minimize both a power consumption of the power optimized storage system and a storage-related performance impact on the at least one client; and
redirecting the I/O request to the selected at least one of the multiple heterogeneous storage devices.

16. The storage system of claim 15 further comprising an intermediate storage-centric device comprising the at least one processing unit and the instructions.

17. The storage system of claim 15 wherein at least one of the multiple heterogeneous storage devices comprises the at least one processing unit and the instructions.

18. The storage system of claim 15, wherein the instructions further cause the at least one processing unit to perform steps comprising: receiving metadata associated with data referenced by the I/O request; wherein the selecting the at least one of the multiple heterogeneous storage devices is further based on the metadata.

19. The storage system of claim 15, wherein the instructions further cause the at least one processing unit to perform steps comprising: selecting data to move from a more power efficient storage device of the power optimized storage system to a less power efficient storage device of the power optimized storage system by referencing lifecycle information associated with the data; and moving the selected data from the more power efficient storage device to the less power efficient storage device so as to maximize utilization of the more power efficient storage device to minimize the power consumption of the power optimized storage system.

20. The storage system of claim 15, wherein the instructions further cause the at least one processing unit to perform steps comprising: copying data from a less power efficient storage device of the power optimized storage system to a more power efficient storage device of the power optimized storage system; and placing the less power efficient storage device into a reduced power consuming state; wherein the redirecting the I/O request comprises redirecting I/O requests from the less power efficient storage device to the more power efficient storage device.
